(19) United States
(12) Patent Application Publication
(10) Pub. No.: US 2009/0277875 A1
(43) Pub. Date: Nov. 12, 2009

(54) Method for the Determination of the Surface Occupation of a Silica Glass Component

(75) Inventors: Karl-Heinz Wiedemann, Brachtal (DE); Juergen Weber, Kleinostheim (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS QUARZGLAS GMBH & CO.KG, Hanau (DE)

(21) Appl. No.: 12/086,515

(22) PCT Filed: Dec. 12, 2006
(86) PCT No.: PCT/EP2006/069593

§ 371 Date: Jun. 13, 2008

(30) Foreign Application Priority Data
Dec. 14, 2005 (DE) 10 2005 060211.8

(51) Int. Cl. B44C 1/22

(52) U.S. Cl. 216/84

(57) ABSTRACT

A method known in prior art for determining the occupation of the surface of a silica glass component with impurities comprises taking a sample, a process in which at least some of the surface of the silica glass component is brought in contact with an acidic desorption solution, and surface impurities that are to be analyzed are accumulated therein and are subjected to an element-specific analysis. The aim of the invention is to create a method which is based on said method, allows the occupation of the surface of silica glass components to be determined accurately and reproducibly, and is suited for determining small amounts of impurities within the order of magnitude of 10¹⁰ atoms/cm² also directly in situ. Said aim is achieved by the fact that taking the sample encompasses contacting the component surface with an acidic desorption solution containing water, nitric acid, and hydrofluoric acid, the nitric acid concentration in the desorption solution amounting to 1.5 to 5 times the hydrofluoric acid concentration (in percent by volume), provided that the contact time and the contact temperature are adjusted such that a maximum of 0.5 ?m of the component surface are removed.

The present invention refers to a method for determining the surface loading of a quartz glass component with impurities, comprising sample taking in which at least a part of the surface of the quartz glass component is brought into contact with an acid desorption solution, surface impurities to be analyzed are collected therein and are subjected to an element-specific analysis

High-quality components of quartz glass are for example used in optical communication technology and in chemical engineering. Moreover, components of quartz glass are used in semiconductor manufacture, for example in the form of reactors and apparatus for treating wafers, diffusion tubes, wafer carriers, bells, crucibles, or the like.

Special attention is paid to the absence of any contamination and to the formation of particles starting from the components, since yield and electrical operating behavior of the semiconductor devices depend on the degree to which in the course of the whole manufacturing process one succeeds in preventing contamination of the wafers with harmful impurities, which are also called “semiconductor poisons”. For instance, impurities generated on the surface of wafers may diffuse into the wafer material in high-temperature treatment steps and result in diffuse electronic transitions or in electronic transitions subject to loss or in premature breakdown.

Contamination caused by heavy metals must here above all be paid attention to, namely iron, copper and also alkali ions that diffuse at a particularly fast rate and may impair the effect of SiO₂ layers serving as electrical insulator layers in the wafer. Since components of quartz glass are extensively used in the course of the manufacturing process, high demands are made on their technical purity, and thus at the same time on the analytical methods for measuring and safeguarding such a property.

For the determination of semiconductor poisons entrapped in the quartz glass volume (bulk), a number of different methods are employed. For instance, spectroscopic methods or chemical analyzing methods in which the quartz glass to be analyzed is dissolved and the impurities contained therein are determined by way of known analytical methods.

Such a method for determining the diffusion coefficient of copper in quartz glass is for instance known from US 2003/0004598 A1. For this purpose a measurement sample is coated with Cu and treated at a temperature of 1050° C. for a period of 24 h. Thereafter, a surface layer of 10 μm is first removed by HF etching to expose a clean surface. The measurement sample cleaned in this way is immersed into an etching solution consisting of 25% HF and 0.1 N nitric acid and is withdrawn again. As a result of the surface tension a layer of the etching solution adheres to the surface. The near-surface area of the quartz glass component is dissolved therein so that the Cu content thereof can be analyzed by way of atomic absorption spectroscopy. In conjunction with the decreasing thickness of the measurement sample a diffusion profile for Cu is obtained in the quartz glass measurement sample by repeating this analysis.

A number of methods are also known for determining impurities on surfaces. To be more specific, methods for analyzing metallic impurities on silicon wafers and contamination causing steps in the manufacture and treatment of semiconductors are often described in the literature.

DE 36 06 748 C1 discloses an arrangement for the non-destructive measurement of metal traces in the area of the surface on silicon wafers, in which the reflection of X-rays from the surface of the silicon wafer is measured and evaluated (TXRF method).

The purity demands made on the surface of quartz glass components can normally be satisfied comparatively easily in production engineering by etching off the near-surface regions by means of hydrofluoric acid. However, there are no reliable or standardized measuring methods for the quantitative and qualitative determination of surface loading prior to or after use of the quartz glass component, for instance for the purpose of quality assurance or for understanding the process in a better way.

Although DIN 51 031 (February 1986) describes a generic method for determining the release of lead and cadmium from silicate-surfaced articles, the area to be analyzed is here exposed to the action of an acetic acid solution at 25° C. for 24 hours. After sample preparation the mass concentrations of the analytes are determined in the extraction solution by means of flame atomic absorption spectroscopy. However, the detection limit of this method is not appropriate for the use of the quartz glass component in the above-mentioned high-technology fields.

It is therefore the object of the present invention to provide a method by means of which the surface loading of quartz glass components can be determined in an exact and reproducible manner and which for the determination of small contamination amounts in the order of 10¹⁰ atoms/cm² is also suited for direct use on site.

Starting from a method of the above-mentioned kind this object is achieved according to the invention in that sample taking comprises contacting the component surface with an acid desorption solution containing water, nitric acid and hydrofluoric acid, the nitric acid concentration in the desorption solution amounting to 1.5 to 5 times the hydrofluoric acid concentration (vol. %), and with the proviso that the content of hydrofluoric acid, the contacting duration and contacting temperature are adjusted such that the component surface is removed to a depth of not more than 0.5 μm.

According to the invention a desorption solution is used containing at least the two components nitric acid and hydrofluoric acid. The nitric acid serves to dissolve impurities that adhere to the surface or directly rest on the surface. As a rule, these are metallic or oxidic impurities reacting with nitric acid with formation of easily soluble nitrates. It has however been found that this measure alone is not adequate for detecting the whole surface loading in economically reasonable treatment periods. This may be due to impurity clusters on the surface that can withstand a dissolution attack by nitric acid for a long period of time. A desorption solution containing only nitric acid may therefore yield a wrong analytical result.

Nevertheless, in order to ensure detection of the whole surface loading within reasonable treatment periods, the desorption solution additionally contains hydrofluoric acid. Said hydrofluoric acid is capable of removing SiO₂ with formation of soluble SiF₄ at a fast rate and is therefore a standard etchant for quartz glass. Due to the etching removal, surface coatings and particularly also possible impurity clusters are infiltrated, removed from the surface in this process and thereby pass into the desorption solution where they are subjected to a further dissolution attack by the nitric acid.

The surface loading with impurities can thereby be detected completely and comparatively easily. However, the etching removal by hydrofluoric acid has the effect that, apart from SiO₂, impurities also pass from near-surface regions into the desorption solution. These impurities ensuing from the “bulk” lead to a distortion of the measurement result, which is to exclusively show the contamination effect of the surface that is due to impurities adhering to the surface and to impurities from the bulk which directly rest on the surface. Therefore, the etching effect of the hydrofluoric acid has to be exclusively limited to an upper surface layer that is as thin as possible.

A suitable compromise between maximum detachment of the surface coating by etching removal and infiltration on the one hand and a minimal distortion of the analytical results due to entry of impurities from the “bulk” on the other hand must be seen according to the invention in the measure that the etching removal is limited to a depth of not more than 0.5 μm. An insignificant etching removal follows from a low concentration of hydrofluoric acid in the desorption solution, a short etching period and/or sample taking at a low temperature. A maximum etching depth of 0.5 μm can be easily determined from the etching rate of the desorption solution.

In the above-mentioned methods for bulk analysis by means of removal methods and subsequent chemical analysis of the removal, etching solutions having a comparatively high content of hydrofluoric acid are used for removing the quartz glass surface layers. By contrast, the desorption solution according to the invention has a nitric acid concentration much higher than the concentration of the hydrofluoric acid, namely between 1.5 to 5 times the hydrofluoric acid concentration (in vol. %).

The concentrations of nitric acid and hydrofluoric acid are here matched to one another such that during the contacting period of the desorption solution with the component surface they can optimally develop their respective effects, i.e. on the one hand the dissolution of the analyte by the nitric acid and on the other hand the infiltration and detachment of possible clusters and coatings by the hydrofluoric acid, which thereby helps the nitric acid to improve its action. To this end concentration ratios in the above-mentioned range have turned out to be a suitable compromise.

The lower the etching removal by the hydrofluoric acid, the less distorted is the analytical result due to the entry of impurities from the bulk material of the quartz glass component. Therefore, a procedure is preferred in which the component surface is removed to a depth of not more than 100 nm.

Nevertheless, in order to detect the surface coating as completely as possible, it has turned out to be useful when the component surface is removed to a depth of at least 5 nm, preferably at least 10 nm.

It has turned out to be advantageous when the mean etching rate of the desorption solution is not more than 0.1 μm/min.

A lower etching rate of less than 0.1 μm makes it easier to observe a predetermined etching removal, especially if, like in the present case, the etching removal should be as small as possible. Preferably, the mean etching rate is 0.05 μm/min at the most.

To ensure an etching removal that is as small as possible together with technologically easily manageable contacting periods of the desorption solution with the component surface, the hydrofluoric acid concentration in the desorption solution is not more than 5 vol. %, the contacting duration lasting from 30 s to 10 min.

Advantageously, the contacting temperature is in the range between 20° C. and 30° C. Contacting temperature is here the temperature of the component surface to be sampled.

In a particularly preferred design of the method according to the invention the nitric acid concentration in the desorption solution is intended to range from 1.8 to 4 times the hydrofluoric acid concentration (in vol. %).

This corresponds to an optimum concentration ratio of nitric acid and hydrofluoric acid, within which the acids develop their respective effects in an optimum way, i.e. on the one hand the dissolution of the analyte by the nitric acid and on the other hand the detachment of possible clusters and coatings by the hydrofluoric acid. Attention must here be paid that the nitric acid may act on still undissolved contamination particles even after removal of the desorption solution from the component surface.

With a view to a sufficiently high dissolving power of the nitric acid, particularly vis-à-vis metallic and oxidic impurities, it has turned out to be advantageous when the desorption solution contains nitric acid in a concentration in the range between 2% by vol. and 10% by vol.

Preferably, contacting the component surface with the desorption solution is carried out by applying the solution charge by charge to the component surface.

The application of the desorption solution charge by charge is e.g. carried out by way of application by means of a pipette, or the like. An exactly metered amount of the desorption solution is here applied to a defined surface region in such a way that the content of analyte per surface ratio of the surface can be determined in an exact way. In this procedure the consumption of high-purity and thus expensive desorption solution is low in comparison with a continuous contacting process or the immersion of the quartz glass component into the solution, and this additionally yields a more pronounced enrichment of the analyte and a low distortion by objectionable contamination of the desorption solution.

In this context it should also be noted that the desorption solution after sample taking is advantageously subjected to a sample preparation for the analysis, which comprises a removal of existing solution matrix and excessive hydrofluoric acid from the sample solution.

After sample taking has been completed, the desorption solution (sample solution) loaded with the analyte is subjected to a sample preparation for analytical purposes. The analyte is here isolated in the solution as much as possible and the ingredients disturbing or distorting the analysis are removed as much as possible. This particularly regards the Si contained in the sample solution, which due to the etching action of the hydrofluoric acid has passed into the desorption solution. Advantageously, the Si in the desorption solution is already present in the form of a highly volatile compound, namely as H₂SiF₆, which decomposes due to evaporation or fuming into the gaseous constituents SiF₄ and HF and therefore can be easily transferred into the gas phase.

Advantageously, the removal of existing solution matrix and excessive hydrofluoric acid from the sample solution encompasses repeated fuming and/or evaporation.

The mass remaining after a fuming or evaporating process is each time newly accommodated in nitric acid, whereby the separation of the SiO₂ matrix from the analyte is further improved. This will improve the reproducibility of the measurement result and the comparability of the measuring method.

After sample preparation the prepared desorption solution is subjected to an elementary analysis by way of atomic spectroscopy, e.g. by means of atomic absorption spectrometry (AAS) or optical emission spectrometry (ICP-OES). Preferably, the analysis is however carried out by way of mass spectroscopy (ICP-MS).

Analysis by mass spectroscopy leads to a particularly high sensitivity with respect to the detection of the impurities that are here of relevance.

To guarantee that the amount of dirt introduced by the operating personnel is as small as possible, and thus to improve the measuring accuracy and reproducibility of the analysis, the taking of samples is preferably automated.

The invention shall now be explained with reference to an embodiment in more detail.

The surface loading of a diffusion tube made from synthetically produced quartz glass is to be determined by way of mass spectroscopy directly before its use for the treatment of silicon wafers. The diffusion tube has an inner diameter of 30.5 cm and a wall thickness of 2.5 mm.

### Sample Taking

250 ml of a desorption solution of the following composition are provided and temperature-controlled to have a temperature of 25° C. (in volume fractions):

| | | |
|---|---|---|
| 20 ml | 65% | HNO₃ correspond to 5.2 vol. % |
| 10 ml | 40% | HF correspond to 1.6 vol. % |
| balance | | H₂O (dist.) |

The diffusion tube is horizontally supported on a roller block and, like the desorption solution, it is also temperature-controlled to have a temperature of 25° C. With the help of an Eppendorf pipette that was previously cleaned with desorption solution, 2.5 ml of the desorption solution are taken and applied to the inside of the diffusion tube. At the same time the diffusion tube is pivoted back and forth continuously by half a rotation. In this process the desorption solution wets the inner wall of the tube over a width of about 5 cm, so that a surface area of about 240 cm² is covered on the whole. An uncontrolled outflow of the desorption solution is here prevented by the wetting between solution and quartz glass surface and by the etching action of the hydrofluoric acid.

After 5 minutes the pivoting movement of the diffusion tube is stopped, so that the desorption solution accumulates and is again taken by means of the Eppendorf pipette and pipetted into a prepared sample bottle (FEP 25 ml).

This yields a sample solution which contains the analytes and further reaction products, among these particularly constituents of the SiO₂ matrix of the quartz glass.

### Sample Preparation

To remove further reaction products that impair the measuring accuracy, the analyte-loaded sample solution is subjected to sample preparation.

To this end the sample solution is heated by way of a microwave and the volatile solution portions are evaporated at a negative pressure of 50 mbar (absolute) in a gentle way for about 60 min. The remaining analyte is again collected in 5.2% HNO₃ solution and is again evaporated for the purpose of removing the H₂SiF₄ matrix (SiF₄+HF) as much as possible. This process is repeated once more.

To minimize the use of volume measuring devices and the accompanying risk of contamination, the analyte is mixed with a rhodium solution as internal standard. Thereafter the analyte which is freed from the H₂SiF₄ matrix to a large extent is collected in about 5 ml of a 1% HNO₃ solution and is subsequently analyzed by mass spectroscopy.

### Analysis

A commercial mass spectroscope HP 4500 of the company Agilent is used for measurement by way of a mass spectroscope.

Table 1 shows the analytical values for typical impurities before and after a basic cleaning of the surface of the quartz glass tube. In the basic cleaning process the inner bore of the quartz glass tube is etched off by using a hydrofluoric acid-containing solution to a depth of 3 μm and is then flushed by means of a cleaning solution containing H₂O, H₂O₂ and HCl.

Basic cleaning constitutes part of quartz glass manufacture and reflects the technical cleanness of the tube, as is found upon delivery or after use and a corresponding cleaning procedure.

The data on the contamination amounts on the inner wall of the tube are standardized in Table 1 to 10¹⁰ atoms/cm². The analytical values regarding Sample 1 indicate the contamination amounts prior to basic cleaning and the values of Sample 2 are indicative of the residual contamination after basic cleaning. The difference between the contamination amounts of Sample 1 and Sample 2 demonstrate the efficiency of the basic cleaning process, while the analysis of Sample 2 is a measure of the technical cleanness or residual contamination of the quartz glass tube.

TABLE 1

| Sample no. | Li | Na | K | Mg | Ca | Fe | Cu | Ni | Cr | Mn | Ti | Al | Zr | V |
|---|---|---|---|---|---|---|---|---|---|---|---|---|---|---|
| 1 | <87 | 2402 | 1202 | 473 | 2465 | 541 | 37 | 41 | 25 | <11 | 399 | 2232 | 9 | <12 |
| 2 | <87 | 100 | 55 | 42 | <15 | 31 | <10 | <10 | <12 | <11 | 35 | 212 | <7 | <12 |

Data in [atoms/cm² *E¹⁰]

1. A method for determining a surface loading of a quartz glass component with impurities, said method comprising:
sample taking in which at least a part of a surface of the quartz glass component is brought into contact with an acid desorption solution, and surface impurities to be analyzed are collected therein and subjected to an element-specific analysis at a contacting temperature for a contacting duration of time,
wherein said sample taking comprises contacting the surface of the quartz glass component with an acid desorption solution containing water, nitric acid and hydrofluoric acid,
the nitric acid and the hydrofluoric acid being present in the desorption solution in a concentration (vol. %) such that the concentration of the nitric acid is 1.5 to 5 times the concentration (vol. %) of the hydrofluoric acid present in the desorption solution, and
the concentration of hydrofluoric acid, the contacting duration and the contacting temperature being selected such that the component surface is removed to a depth of not more than 0.5 μm.

2. The method according to claim 1 wherein the surface of the quartz glass component is removed to a depth of not more than 100 nm.

3. The method according to claim 1 wherein the surface of the quartz glass component is removed to a depth of at least 5 nm

4. The method according to claim 1 wherein the desorption solution produces a mean etch rate that is not more than 0.1 μm/min.

5. The method according to claim 4 wherein the mean etch rate is not more than 0.05 μm/min.

6. The method according to claim 1 wherein the concentration of hydrofluoric acid in the desorption solution is not more than 5 vol. %, and the contacting duration ranges from 30 to 10 min.

7. The method according to claim 1 wherein the contacting temperature is within a range between 20° C. and 30° C.

8. The method according to claim 1 wherein the concentration of nitric acid in the desorption solution is 1.8 to 4 times the concentration of hydrofluoric acid (in vol. %).

9. The method according to claim 1 wherein in the desorption solution the concentration of nitric acid is in a range from 2 vol. % to 10 vol. %.

10. The method according to claim 1 wherein contacting the component surface with the desorption solution comprises applying the solution charge by charge to the surface of the quartz glass component.

11. The method according to claim 1 wherein after the sample taking the desorption solution is subjected as a sample solution to a sample preparation for analysis, which includes removal of an existing solution matrix and excessive hydrofluoric acid from the sample solution.

12. The method according to claim 11 wherein the existing solution matrix and the excessive hydrofluoric acid are removed from the sample solution by repeated fuming or evaporation.

13. The method according to claim 1 wherein the analysis is performed using mass spectroscopy.

14. The method according to claim 1 wherein the sample taking is automated.

15. The method according to claim 1 wherein the surface of the quartz glass component is removed to a depth of at least 10 nm.
